(19) United States
(12) Patent Application Publication
(10) Pub. No.: US 2024/0042559 A1
(43) Pub. Date: Feb. 8, 2024

(54) PART MANIPULATOR FOR ASSEMBLY MACHINE

(71) Applicants: TE Connectivity Solutions GmbH, Schaffhausen (CH); Tyco Electronics (Shanghai) Co., Ltd., Shanghai (CN)

(72) Inventors: Sonny O. Osunkwo, Harrisburg, PA (US); Xianghao Bao, Shanghai (CN); Roberto Francisco-Yi Lu, Bellevue, WA (US); Swapnilsinh Solanki, Harrisburg, PA (US); Du Wen, Reading, PA (US); Lei Zhou, Shanghai (CN); Pablo Plascencia, Middletown, PA (US); Kellen Haile, Middletown, PA (US); Dongfang Zong, Shanghai (CN)

(21) Appl. No.: 18/078,191

(22) Filed: Dec. 9, 2022

(30) Foreign Application Priority Data
Aug. 5, 2022 (CN) 202210936735.X

(51) Int. Cl. B23P 19/04; B25J 11/00

(52) U.S. Cl. CPC B23P 19/04; B25J 11/005

(57) ABSTRACT

A part manipulator includes a robot arm movable in three-dimensional space between a pick station and a place station. The part manipulator includes an end effector coupled to a distal end of the robot arm. The end effector includes a rotation platform rotatable between a first position and a second position. The end effector includes a part gripper coupled to the rotation platform movable between a releasing position and a holding position. The part gripper is configured to hold a part in the holding position. The part gripper is rotated by the rotation platform as the rotation platform is rotated from the first position to the second position to move the part from a picking orientation to a placing orientation. The end effector picks up the part in the picking orientation at the pick station. The end effector releases the part in the placing orientation at the place station.

### CROSS REFERENCE TO RELATED APPLICATIONS

This application claims benefit to Chinese Application No. 202210936735.X, filed 5 Aug. 2022 the subject matter of which is herein incorporated by reference in its entirety.

### BACKGROUND OF THE INVENTION

The subject matter herein relates generally to part assembly machines.

Part assembly machines are used to assemble parts into products using machine building processes rather than manual, hand building processes. Part assembly machines reduce assembly time and cost. However, automated assembly may be difficult. For example, the parts need to be oriented in a particular orientation for assembly. Conventional part assembly machines use a part feeder, such as a vibrating tray, that holds the parts. The parts may be in various different orientations on the part feeder. Conventional machines continually actuate the feeder tray until the parts are in the correct orientation for the pick-and-place device to pick up the parts. Such actuation takes time to properly orient the parts, delaying operating time of the pick-and-place device and reducing throughput of the part assembly machine. Other machines use a separate part orientation device that picks up each part and properly orients the part for the pick-and-place device to retrieve. However, the part orientation device increases the overall cost of the machine and may increase operating time, thus reducing throughput of the part assembly machine.

A need remains for a part assembly machine that may be operated in a cost effective and reliable manner.

### BRIEF DESCRIPTION OF THE INVENTION

In one embodiment, a part manipulator is provided and includes a robot arm movable in three dimensional space. The robot arm is movable between a pick station and a place station. The part manipulator includes an end effector coupled to a distal end of the robot arm. The end effector includes a rotation platform rotatable between a first position and a second position. The end effector includes a part gripper coupled to the rotation platform. The part gripper is movable between a releasing position and a holding position. The part gripper is configured to hold a part in the holding position. The part gripper is rotated by the rotation platform as the rotation platform is rotated from the first position to the second position to move the part from a picking orientation to a placing orientation. The end effector is configured to pick up the part in the picking orientation at the pick station. The end effector is configured to release the part in the placing orientation at the place station.

In another embodiment, a part assembly machine is provided and includes a pick station having a part feeder. The part feeder has a platform supporting parts. The part assembly machine includes a vision inspection station positioned adjacent the part feeder. The vision inspection station includes an imaging device to image the parts in a field of view above the platform. The part assembly machine includes a controller receiving images from the imaging device. The controller determines orientations of the parts on the platform from a plurality of possible orientations. The possible orientations includes a picking orientation. The controller determines locations of each part in the picking orientation. The part assembly machine includes a part manipulator positioned adjacent the pick station to successively pick up the parts in the picking orientation from the part feeder. The part manipulator is configured to place the parts at a place station. The part manipulator includes a robot arm and an end effector coupled to a distal end of the robot arm. The robot arm is operably coupled to the controller. The robot arm movable in three dimensional space between the pick station and the place station. The end effector operably coupled to the controller. The end effector includes a rotation platform rotatable between a first position and a second position. The end effector includes a part gripper coupled to the rotation platform. The part gripper is movable between a releasing position and a holding position. The part gripper is configured to hold the corresponding part in the holding position, The part gripper is rotated by the rotation platform as the rotation platform is rotated from the first position to the second position. The controller operates the robot arm to successively position the end effector proximate to the parts in the picking orientations. The controller operates the end effector to pick up the corresponding part in the picking orientation at the pick station. The controller operates the end effector to rotate the rotation platform from the first position to the second position to move the part from the picking orientation to a placing orientation. The controller operates the robot arm to move the end effector to the place station after the part is picked up. The controller operates the end effector to release the part in the placing orientation at the place station.

In a further embodiment, a method of assembling parts is provided and includes loading the parts on an upper surface of a platform of a part feeder. The method images the parts on the platform using an imaging device and processes images to determine orientations of the parts on the platform from a plurality of possible orientations. The possible orientations include a picking orientation. The controller determines locations of each part in the picking orientation. The method successively picks up the parts that are in the picking orientation using a part manipulator includes a robot arm movable in three dimensional space and an end effector coupled to a distal end of the robot arm that includes a rotation platform rotatable between a first position and a second position and a part gripper coupled to the rotation platform, The part gripper is moved from a releasing position to a holding position to pick up the parts that are in the picking orientation. After the part is picked up by the end effector, the method operates the rotation platform to rotate from the first position to the second position to rotate the part from the picking orientation to a placing orientation. The method operates the robot arm to move the end effector and the part to a place station in the placing orientation and operates the end effector to release the part, in the placing orientation, at the place station.

### BRIEF DESCRIPTION OF THE DRAWINGS

FIG. 1 is a schematic illustration of a part assembly machine for assembling parts, such as parts used to form electrical connectors in accordance with an exemplary embodiment.

FIG. 2 is a top view of the part assembly machine in accordance with an exemplary embodiment.

FIG. 3 is an image taken by the imaging device in accordance with an exemplary embodiment.

FIG. 4 illustrates examples of the part in different orientations device in accordance with an exemplary embodiment.

FIG. 5 is a front perspective view of a portion of the part manipulator in accordance with an exemplary embodiment.

FIG. 6 is a rear perspective view of a portion of the part manipulator in accordance with an exemplary embodiment.

FIG. 7 is a front perspective view of a portion of the part manipulator in accordance with an exemplary embodiment.

FIG. 8 is a flow chart showing a method of assembling parts in accordance with an exemplary embodiment.

### DETAILED DESCRIPTION OF THE INVENTION

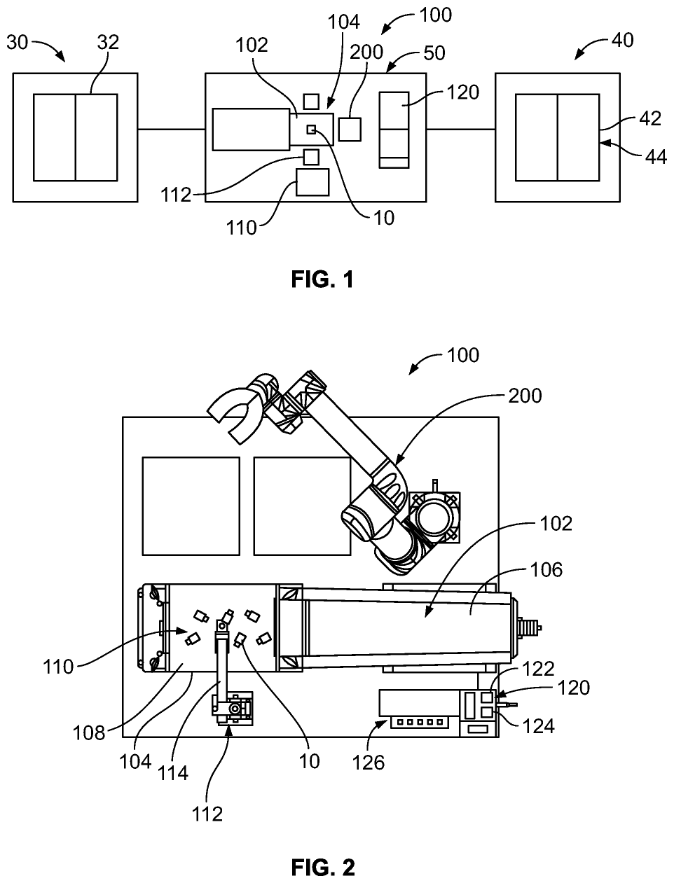

FIG. 1 is a schematic illustration of a part assembly machine 100 for assembling parts 10, such as parts used to form electrical connectors. For example, the parts 10 may be contacts, housings, circuit boards, or other types of parts. The part assembly machine 100 may be used for assembling products used in other industries. The part assembly machine 100 includes one or more forming machines 30 at a forming station 32 used to form various parts 10. For example, the forming machines may include a molding machine, a press, a lathe, and the like. The part assembly machine 100 includes one or more processing machines 40 at a processing station 42 used for processing the various parts 10. For example, the processing station 42 may include an assembly station, a part loading station, a part soldering station, a part termination station, a part packaging station, and the like. The processing machine defines a place station 44 for placing the part 10, such as in another product, on another product, or in a package.

The part assembly machine 100 includes a part feeder 102 that supports the parts 10, such as for transport and/or inspection between the forming machine 30 and the processing machine 40. The part feeder 102 is used to feed or move the parts 10 through the part assembly machine 100. In an exemplary embodiment, the parts 10 may be loaded onto the part feeder 102 in any random orientation (for example, facing forward, facing rearward, facing sideways, facing upward, facing downward, and the like). The part assembly machine 100 is able to support the parts without the need for fixturing, which increases the throughput of the parts 10 through the part assembly machine 100. The parts 10 are picked up from the part feeder 102. As such, the part feeder 102 defines a pick station 50, at which the parts are picked.

In an exemplary embodiment, the part assembly machine 100 includes a vision inspection station 110 having one or more imaging devices 112 that image the parts 10 on the part feeder 102 within a field of view of the imaging device(s) 112. In the illustrated embodiment, the vision inspection station 110 includes multiple imaging devices 112 for imaging different sides of the parts 10. The imaging device 112 is able to image the parts 10 in the random orientations. In an exemplary embodiment, the vision inspection station 110 may be used to inspect different types of parts 10. For example, the vision inspection station 110 may be used to inspect different sized parts, different shaped parts, parts in different orientations, and the like.

In an exemplary embodiment, the part assembly machine 100 includes a controller(s) 120 for controlling operation of the various components of the part assembly machine 100. The controller 120 receives the images from the imaging device 112 and processes the images to determine inspection results. For example, the controller 120 determines the orientations of each of the parts 10 on the parts feeder 102. The controller 120 may inspect the parts, such as for quality and may reject parts that are defective. In an exemplary embodiment, the controller 120 includes a shape recognition tool configured to determine the orientations of the parts 10 in the field of view on the parts feeder 102. The images may be processed by performing pattern recognition of the images based on an image analysis model. The shape recognition tool may compare shapes, patterns or features in the images to shapes, patterns or features in the image analysis model. The images may be processed by performing feature extraction of boundaries and surfaces detected in the images and comparing the boundaries and surfaces to the image analysis model. The controller 120 may identify lines, edges, bridges, grooves, or other boundaries or surfaces within the image. The processing of the images may provide image contrast enhancement for improved boundary or surface identification. In an exemplary embodiment, the controller 120 includes an artificial intelligence (AI) learning module used to customize and configure image analysis based on the images received from the imaging device 112. The controller 120 may be updated and trained in real time during operation of part assembly machine 100. For example, the AI learning module may update and train the controller 120 in real time during operation of the vision inspection station 110.

The vision inspection station 110 includes a part manipulator 200 for moving the parts 10, such as from the parts feeder 102 to the processing machine 40, based on the inspection results. For example, the part manipulator 200 may pick up the parts 10 from the parts feeder 102 and place the parts 10 at the processing machine 40, such as for assembly. In an exemplary embodiment, the part manipulator 200 may be a multi-axis robot manipulator configured to grip and pick the parts off of the parts feeder 102 and move the parts 10 in three-dimensional space.

FIG. 2 is a top view of the part assembly machine 100 in accordance with an exemplary embodiment. The part assembly machine 100 includes the parts feeder 102, the vision inspection station 110, the controller 120, and the part manipulator 200.

In an exemplary embodiment, the parts feeder 102 includes a platform 104 and a part feeding device 106. The parts 10 are loaded onto the platform 104 by the part feeding device 106, which may include a hopper, a conveyor, a robot, or another type of feeding device. The parts 10 are presented to the inspection station 110 on the platform 104. The parts 10 may be advanced or fed along the platform 104, such as by vibration of the platform 104. The parts 10 are removed from the platform 104 by the part manipulator 200. The platform 104 may include a plate having an upper surface 108 used to support the parts 10. The platform 104 may be a vibration tray that is vibrated to advance the parts 10. The platform 104 may be rectangular. However, the platform 104 may have other shapes in alternative embodiments, such as a round shape.

The inspection station 110 includes one or more imaging devices 112 (a single imaging device 112 is illustrated in FIG. 2) arranged adjacent the platform 104. The imaging device 112 may be located above the upper surface 108 and view the parts 10 arranged on the upper surface 108. The imaging device 112 may be a camera, such as a visible light camera, an infrared camera, and the like. The field of view of the imaging device 112 may include the entire surface of the platform 104. The imaging device 112 may be mounted to a position manipulator 114 for moving the imaging device 112 relative to the platform 104. The position manipulator 114 may be an arm or a bracket that supports the imaging device 112. In various embodiments, the position manipulator 114 may be positionable in multiple directions, such as in two-dimensional or three-dimensional space. The position manipulator 114 may be automatically adjusted, such as by the controller 120, to control positioning of the position manipulator 114. In other various embodiments, the position manipulator 114 may be manually adjusted. The position of the imaging device 112 may be adjusted based on the types of parts 10 being imaged. For example, when a different type of part 10 is being imaged, the imaging device 112 may be moved based on the type of part being imaged.

The part manipulator 200 is positioned adjacent the platform 104. The part manipulator 200 is used to pick up the parts 10 that are in a particular orientation(s) based on input from the imaging device 112. In an exemplary embodiment, the part manipulator 200 includes a robot arm 210 and an end effector 220 at a distal end 212 of the robot arm 210. The end effector 220 may be a mechanical gripper or vacuum gripper configured to pick up the part 10. In various embodiments, the robot arm 210 is a four-axis robot arm or a six-axis robot arm. Other types of robot arms may be used in alternative embodiments. The parts 10 are picked up off of the platform 104 by the end effector 220. In various embodiments, the part manipulator 200 is operated to remove some or all of the parts 10 that are in a particular orientation, such as in a picking orientation. In an exemplary embodiment, the part manipulator 200 is operated to change the orientation of the parts 10 after the parts 10 are picked up to orient the parts in a predetermined orientation, such as a placing orientation (different than the picking orientation), that is a desired orientation for assembly. After all of the parts 10 in the picking orientation are removed, the parts feeder 102 may be operated to change the orientations of the remaining parts 10, such as vibrating the platform 104 to change the orientations of the parts 10. The part manipulator 200 is then operated again to pick up the newly oriented parts 10 that are in the picking orientation.

The controller 120 includes one or more processors 122 for processing the images. The controller 120 is operably coupled to the imaging device 112 and the part manipulator 200 for controlling operation of the part manipulator 200. The imaging device 112 communicates with the controller 120 through machine vision software to process the data, analyze results, record findings, and make decisions based on the information. The controller 120 provides consistent and efficient inspection automation. The controller 120 determines the orientations of the parts 10 to determine which parts 10 are ready to be picked and placed by the part manipulator 200. The controller 120 controls operation of the part manipulator 200 based on the identified locations (x, y, z) and orientations (for example, heading and facing directions) of the parts 10. The controller 120 includes a communication module 124 for communicating with the various components of the part assembly machine 100. The communication module 124 may communicate via wired connections or wireless communication. In an exemplary embodiment, the controller 120 includes a user interface 126. The user interface 126 includes a display, such as a monitor. The user interface 126 includes one or more inputs, such as a keyboard, a mouse, buttons, and the like. An operator is able to interact with the controller 120 with the user interface 126.

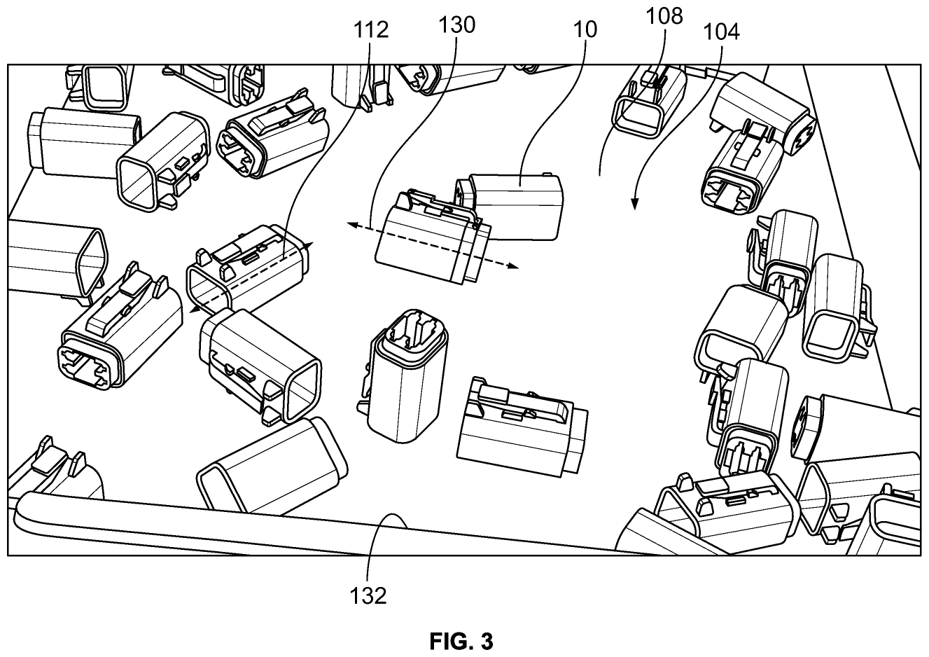

FIG. 3 is an image taken by the imaging device 112 in accordance with an exemplary embodiment. FIG. 3 shows a plurality of the parts 10 on the upper surface 108 of the platform 104. The parts 10 are randomly arranged on the platform 104 at various positions and in various orientations. The orientation of each part is determined by determining a heading direction 130 of the part (angular orientation of the longitudinal axis of the part relative to a datum 132 (for example, end) of the platform of the parts feeder) and the facing direction of the part (the surface of the part that is resting on the platform of the parts feeder). For example, the facing direction may be a top facing direction (top resting on the platform 104), a bottom facing direction (bottom resting on the platform 104), a front facing direction (front resting on the platform 104), a rear facing direction (rear resting on the platform 104), a first side facing direction (first side resting on the platform 104), a second side facing direction (second side resting on the platform 104), and the like.

In an exemplary embodiment, for efficient part picking, the part manipulator 200 (shown in FIG. 2) is configured to pick up the parts in a certain orientation, also referred to as a picking orientation. The picking orientation may be the most commonly occurring orientation for the particular part. Other parts, that are in other orientations, are ignored by the part manipulator 200. Once all of the parts 10 in the picking orientation are removed, the platform 104 is vibrated to change the orientations of the remaining parts 10, causing new orientations. The parts 10 then in the picking orientation are targeted by the part manipulator 200 for picking and placing.

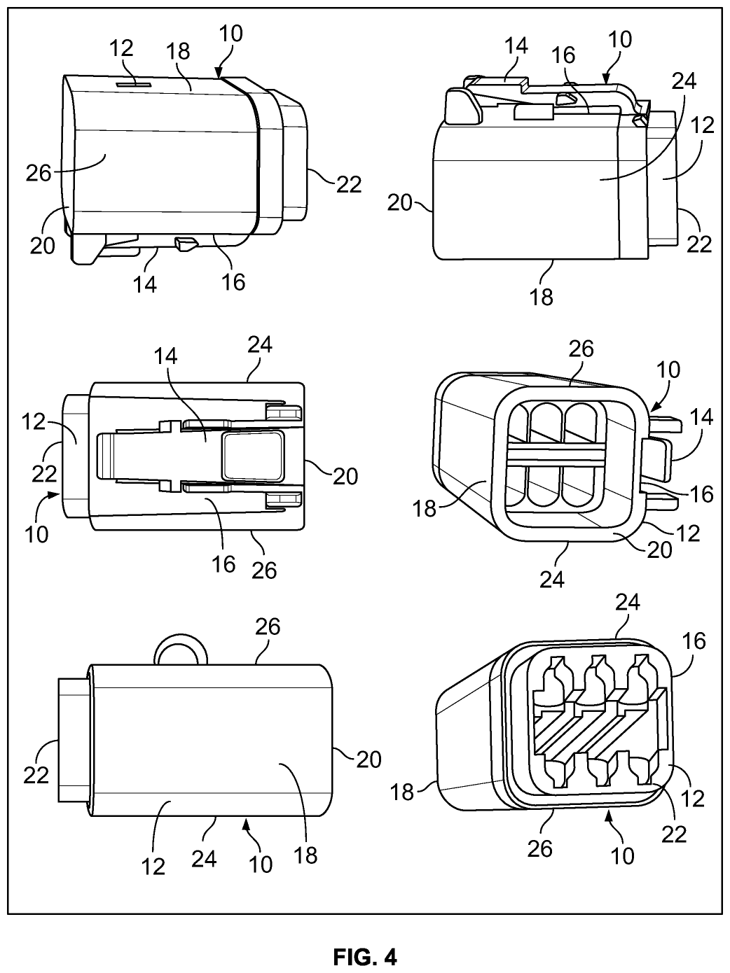

FIG. 4 illustrates examples of the part 10 in different orientations. In the illustrated embodiment, the part 10 is a connector housing 12 of an electrical connector having a latch 14 for latchably coupling the connector housing 12 to a mating electrical connector. In the illustrated embodiment, the connector housing 12 is generally parallelpiped (for example, box-shaped) having six sides. The part 10 includes a top 16 and a bottom 18 opposite the top 16. The latch 14 is provided at the top 16 and thus the position of the latch defines the top of the part 10. The part 10 includes a front and a rear 22 opposite the front 20. The latching end of the latch 14 faces the front and thus the orientation of the latch 14 defines the front of the part 10. The part 10 includes a first side 24 and a second side 26 opposite the first side 24. The part 10 may include other sides or surfaces in alternative embodiments. The part 10 may have other shapes in alternative embodiments.

The part 10 may rest on the platform 104 (shown in FIG. 2) on any of the sides. FIG. 4 shows the different orientations. Orientation 1 shows the part on the first side 24 (first side orientation). Orientation 2 shows the part 10 on the second side 26 (second side orientation). Orientation 3 shows the part 10 on the bottom 18 (bottom orientation). Orientation 4 shows the part 10 on the rear 22 (rear orientation). Orientation 5 shows the part 10 on the top 16 (top orientation). Orientation 6 shows the part 10 on the front 20 (front orientation). Some orientations may occur more readily or more naturally than other orientations. For example, the front orientation and the rear orientation are less likely to occur because the part 10 tends to orient in a shorter orientation rather than a taller orientation. Additionally, the top orientation is less likely to occur because the part 10 rests upon the latch 14 in the top orientation. In contrast, the part 10 is more likely to rest upon a flat surface rather than resting on the latch 14. In an exemplary embodiment, the bottom orientation is the most likely orientation and thus the most common orientation. In an exemplary embodiment, the part manipulator 200 is controlled to pick up the parts 10 that are in the most common orientation and thus the bottom orientation defines the picking orientation. However, the part manipulator 200 may be controlled to pick up the parts 10 in different orientations, such as the first side orientation and/or the second side orientation.

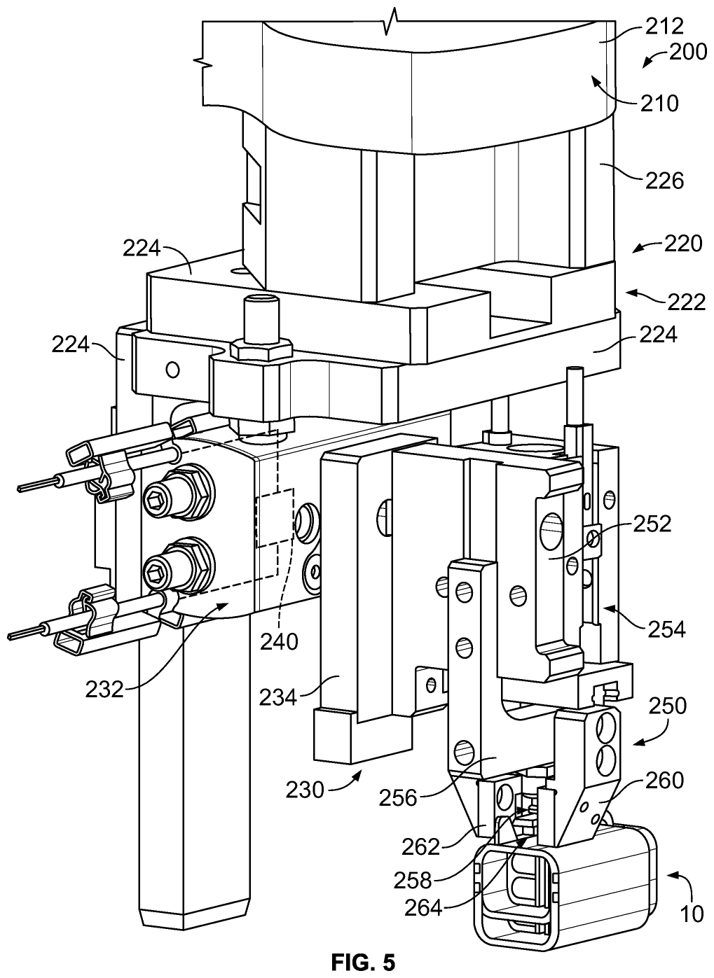

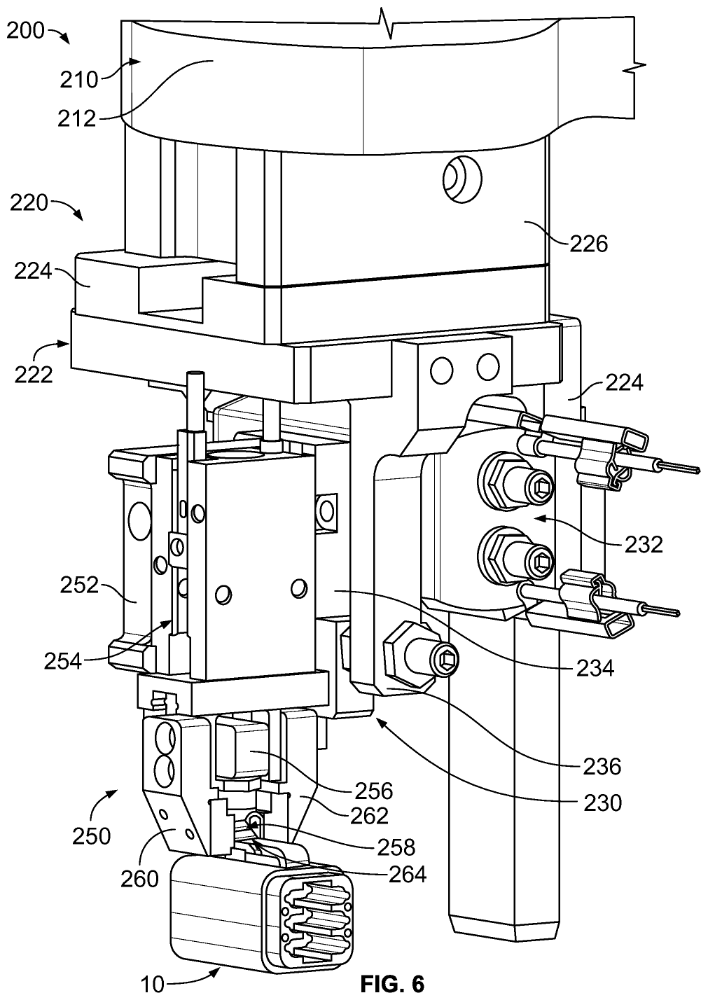

FIG. 5 is a front perspective view of a portion of the part manipulator 200 in accordance with an exemplary embodiment. FIG. 6 is a rear perspective view of a portion of the part manipulator 200 in accordance with an exemplary embodiment. FIGS. 5 and 6 illustrate the end effector 220 provided at the distal end 212 of the robot arm 210. FIGS. 5 and 6 show the end effector 220 holding one of the parts 10. The part 10 is shown in the picking orientation (for example, the bottom orientation).

In an exemplary embodiment, the end effector 220 includes a mounting bracket 222, a rotation platform 230 coupled to the mounting bracket 222, and a part gripper 250 coupled to the rotation platform 230. The mounting bracket 222 is mounted to the robot arm 210. In an exemplary embodiment, the mounting bracket 222 includes one or more mounting plates 224 used to support the components of the end effector 220 and a mounting base 226 coupled to the distal end 212 of the robot arm 210. In various embodiments, the mounting plates 224 and the mounting base 226 are manufactured from a metal material, such as steel. The mounting plate 224 and the mounting base 226 may be machined to include openings, slots, or other features used to support the components of the end effector 220. The mounting base 226 may be secured to the robot arm 210 using bolts, latches, clips, or other mounting features. The end effector 220 is moved in three-dimensional space by the robot arm 210.

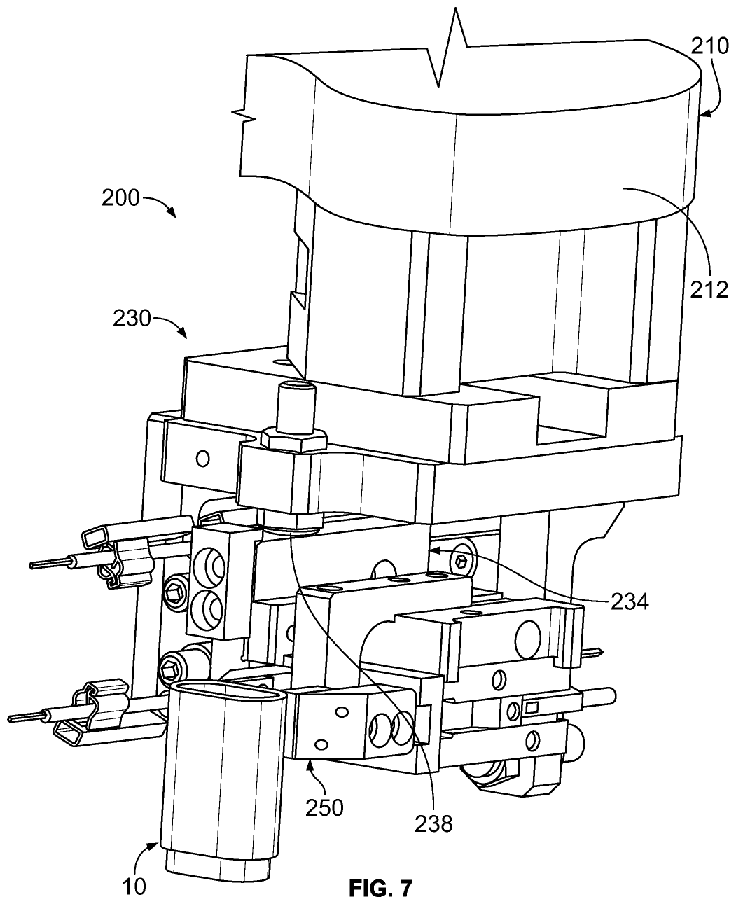

The rotation platform 230 is coupled to one or more of the mounting plates 224. For example, the rotation platform 230 may be coupled to the mounting plates 224 using bolts. The rotation platform 230 is operated to rotate the part gripper 250 relative to the mounting bracket 222. In an exemplary embodiment, the rotation platform 230 includes a rotation platform actuator 232 and a rotation plate 234 operably coupled to the rotation platform actuator 232. The rotation platform actuator 232 is configured to rotate the rotation plate 234 from a first position (FIGS. 5 and 6) to a second position (FIG. 7). In various embodiments, the first position and the second position are oriented 90° relative to each other. However, the rotation plate 234 may be rotated other amounts in alternative embodiments. In various embodiments, the first position may be a vertical position and the second position may be a horizontal position. In an exemplary embodiment, the rotation platform actuator 232 is an electric actuator having an electric motor that rotates a shaft coupled to the rotation plate 234. In other various embodiments, the rotation platform actuator 232 is a pneumatic actuator operated to rotate the rotation plate 234. Other types of actuators may be used in alternative embodiments.

In an exemplary embodiment, the rotation platform 230 includes a rotation stop 236 (FIG. 6) used to control or stop rotation of the rotation platform 230. The rotation plate 234 may engage the rotation stop 236 in the first position. The rotation stop 236 restricts movement of the rotation plate 234 beyond a limit defined by the rotation stop 236. In an exemplary embodiment, the rotation stop 236 is adjustable. For example, the rotation stop 236 may include an adjustment bolt that may be rotated to change a location of the stop surface of the rotation stop 236. Other types of rotation stops may be used in alternative embodiments.

In an exemplary embodiment, the rotation platform 230 includes a rotation platform sensor 240 coupled to the rotation platform actuator 232 and/or the rotation plate 234 to determine an angular position of the rotation platform 230 (for example, a in angular position of the rotation plate 234). Signals from the rotation platform sensor 240 may be used to verify the position of the rotation platform 230 for picking and placing the parts 10.

In an exemplary embodiment, the part gripper 250 is used to mechanically pick up and hold the part 10, such as for movement of the part 10 from the parts feeder 102 to the assembly station at the processing machine 40. In the illustrated embodiment, the part gripper 250 includes a first gripper jaw 260 and a second gripper jaw 262 that may be opened and closed relative to each other. A holding space 264 is defined between the first and second gripper jaws 260, 262. The part 10 may be held in the holding space 264 between the first and second gripper jaws 260, 262. Other types of part grippers 250 may be used in alternative embodiments to pick up and hold the part 10. For example, the part gripper 250 may include vacuum elements used to hold the part 10 by vacuum pressure.

The part gripper 250 is coupled to the rotation platform 230. For example, a mounting plate 252 of the part gripper 250 may be coupled to the rotation plate 234 using fasteners. As such, the mounting plate 252 may be removable from the rotation plate 234. The mounting plate 252 is rotatable with the rotation plate 234. For example, as the rotation platform 230 is rotated between the first position and the second position, the mounting plate 252 is moved with the rotation platform 230 between the first position and the second position.

In an exemplary embodiment, the part gripper 250 includes a part gripper actuator 254 coupled to the mounting plate 252. The part gripper actuator 254 is operated to pickup and release the part 10. The part gripper actuator 254 is operably coupled to the first gripper jaw 260 and/or the second gripper jaw 262 to open and close the part gripper 250 for pickup and release of the part 10. In an exemplary embodiment, the part gripper actuator 254 is an electric actuator having an electric motor that opens and closes the gripper jaws 260, 262. In other various embodiments, the part gripper actuator 254 is a pneumatic actuator operated to open and close the gripper jaws 260, 262. Other types of actuators may be used in alternative embodiments.

In an exemplary embodiment, the part gripper 250 includes a mounting bracket 256 coupled to the mounting plate 252. The mounting bracket 256 supports a gripper sensor 258 used for detecting a position of the part gripper 250 relative to the part 10. In the illustrated embodiment, the mounting bracket 256 holds the gripper sensor 258 in the holding space 264 between the gripper jaws 260, 262. Gripper sensor 258 may detect the presence of the part 10 in the holding space 264. The gripper sensor 258 may be a proximity sensor. Other types of sensors may be used in alternative embodiments, such as pressure sensors.

FIG. 7 is a front perspective view of a portion of the part manipulator 200 in accordance with an exemplary embodiment. FIG. 7 illustrates the end effector 220 provided at the distal end 212 of the robot arm 210. FIG. 7 shows the end effector 220 holding one of the parts 10. The part 10 is shown in the placing orientation (for example, the rear orientation). The part 10 may be moved to the processing machine 40, such as to an assembly station, in the placing orientation and held in the placing orientation by the part manipulator 200 for loading contacts into the connector housing.

The rotation platform 230 is operated to rotate the part gripper 250 to the second position. In an exemplary embodiment, the rotation platform 230 rotate the part gripper 250 and the part 10 along an arcuate path (for example, 90°) from the first position (FIGS. 5 and 6) to the second position (FIG. 7). In various embodiments, the first position may be a vertical position and the second position may be a horizontal position. In an exemplary embodiment, the rotation platform 230 includes a rotation stop 238 used to control or stop rotation of the rotation platform 230 in the second position. The rotation plate 234 may engage the rotation stop 238 in the second position. The rotation stop 238 restricts movement of the rotation plate 234 beyond a limit defined by the rotation stop 238. In an exemplary embodiment, the rotation stop 238 is adjustable. For example, the rotation stop 238 may include an adjustment bolt that may be rotated to change a location of the stop surface of the rotation stop 238. Other types of rotation stops may be used in alternative embodiments.

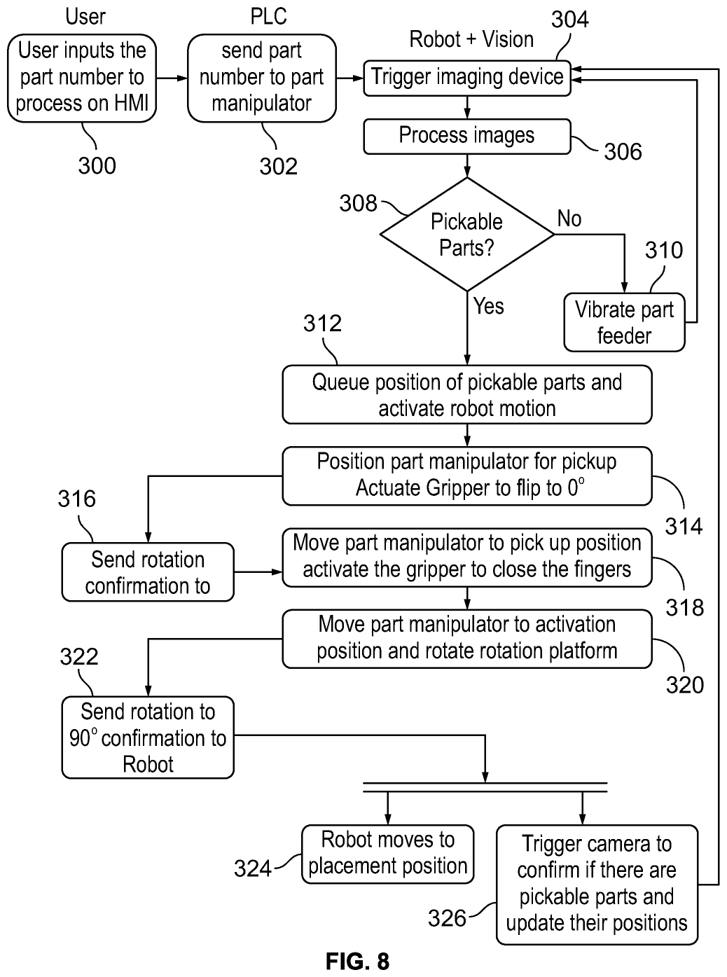

FIG. 8 is a flow chart showing a method of assembling parts in accordance with an exemplary embodiment. The method, at 300, includes inputting the part numbers or type of parts being assembled by the part assembly machine. The user may manually enter the part numbers or select the type of parts being assembled, such as into a user interface of the part assembly machine. The parts are loaded onto the platform of the parts feeder.

At 302, the method includes sending control signals to the part manipulator based on the type of parts being assembled. The control signals control positioning of the part manipulator relative to the platform. For example, the control signals control the vertical positioning of the part manipulator (for example, the end effector of the part manipulator) for picking up the parts based on the type of parts being assembled.

At 304, the controller triggers the imaging device to capture an image of the parts on the platform of the parts feeder. At 306, the controller processes the images. The image is analyzed by the controller to determine orientations of each of the parts (for example, top orientations, bottom orientations, front orientations, rear orientations, first side orientations, second side orientations, and the like). The imaging may be performed quickly and efficiently using the imaging device. The image may be processed using an image analysis model, which is based on the type of parts being assembled. The image analysis model may include a shape recognition tool to determine locations and orientations of the parts. In various embodiments, the images are processed by performing pattern recognition of the images based on the image analysis model. In various embodiments, the images are processed by performing feature extraction of boundaries and surfaces detected in the images and comparing the boundaries and surfaces to the image analysis model. The orientation of each part is determined by determining a heading direction of the part (angular orientation of the longitudinal axis of the part relative to a datum (for example, end) of the platform of the parts feeder) and the facing direction of the part (the surface of the part that is resting on the platform of the parts feeder).

At 308, the controller determines if there are any pickable parts based on the image analysis. The pickable parts are the parts that are in a predetermined orientation, namely a picking orientation. The picking orientation is based on the type of parts being assembled. In various embodiments, the parts may have a single picking orientation (for example, a bottom orientation). However, in other various embodiments, the parts may have multiple picking orientations (for example, a first side orientation and a second side orientation). The controller determines the number of parts in the picking orientation and determines the locations of the parts in the picking orientation. At 310, if there are no pickable parts, the controller sends a signal to the parts feeder to vibrate the parts feeder to flip the parts on the platform and change the orientations of the parts on the platform. After the parts feeder is vibrated, the method returns to step 304 to trigger the camera to capture another image. At 312, if there are pickable parts, the controller queues the positions (x, y, z) and the orientations (heading direction, facing direction) of each of the pickable parts to the parts manipulator.

At 314, the controller positions the part manipulator for part pick-up. The controller causes the robot arm to move to a pick-up staging position. The pick-up staging position may be aligned vertically above the part. The pick-up staging position may be located a z-offset distance above the part such that the part manipulator does not interfere with or touch the part in the elevated pick-up position. The controller operates the rotation platform actuator. The controller causes the rotation platform to return to the first position (for example, 0° position or vertical position). At 316, the rotation platform sends a confirmation signal to the controller of the position of the rotation platform.

At 318, the controller causes the part manipulator to move to a pick-up position and pick-up the part. The controller moves the robot arm from the staging position to the pick-up position to allow the part gripper to engage and pick-up the part. The robot arm may be moved in a downward vertical direction from the staging position to the pick-up position. The controller operates the gripper actuator. The controller causes the part gripper to engage the part. For example, the gripper jaws may be closed to secure the part in the part gripper.

At 320, the controller causes the part manipulator to move to an actuation position. The controller operates the rotation platform actuator in the actuation position. The controller causes the rotation platform to move to the second position (for example, 90° position or horizontal position). In various embodiments, the actuation position may be the same as the staging position. For example, the actuation position may be located directly vertically above the pick-up position. The robot arm is moved away from the platform to the actuation position to allow the rotation platform to rotate without interference from other parts or other components of the system. The actuation position may be a fixed position. Alternatively, the actuation position may not be fixed, but rather be a set of positions that is in a clearance zone where the end effector is clear of the parts feeder. The rotation platform may be free to move from the first position to the second position within the clearance zone, even if the robot arm is moving. As such, the rotation of the rotation platform may be performed on-the-fly as the robot arm is moving to a different location, such as to the assembly station. The on-the-fly rotation fo the rotation platform reduces the overall assembly time compared to pausing the part manipulator at a stationary position to perform the rotation of the rotation platform from the first position to the second position. The rotation of the rotation platform moves the part from the picking orientation to the placing orientation. At 322, the rotation platform sends a confirmation signal to the controller of the position of the rotation platform after the rotation platform is moved to the second position.

At 324, the controller moves the end effector to a placement position. The controller causes the robot arm to move to the processing machine, such as to an assembly station. The assembly machine may be remote from the parts feeder. The part is configured to be processed at the processing station. For example, the part may be assembled with other parts at an assembly machine, such as loading contacts into the connector housing. The part may be attached to another part, such as mounting the part to a circuit board. The part is held in the placing orientation by the part manipulator. The part may be moved to multiple stations for multiple processes. The part may be released by the part manipulator after being processed. At 326, as the part manipulator is moving from the pick station to the place station, the controller triggers a return to step 304 to cause the imaging device to capture an image for processing to determine if there are still pickable parts. The process may continue until all of the parts have been assembled.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. A part manipulator comprising:
a robot arm movable in three dimensional space, the robot arm movable between a pick station and a place station;
an end effector coupled to a distal end of the robot arm, the end effector including a rotation platform coupled to the distal end of the robot arm and movable independent of the robot arm, the rotation platform rotatable between a first position and a second position, the end effector including a part gripper coupled to the rotation platform, the part gripper movable between a releasing position and a holding position, the part gripper configured to hold a part in the holding position, wherein the part gripper is rotated by the rotation platform as the rotation platform is rotated from the first position to the second position to move the part from a picking orientation to a placing orientation;
wherein the end effector is configured to pick up the part in the picking orientation at the pick station; and
wherein the end effector is configured to release the part in the placing orientation at the place station.

2. The part manipulator of claim 1, wherein the first position is oriented 90° relative to the second position.

3. The part manipulator of claim 1, wherein the rotation platform is operable independently of operation of the robot arm, the rotation platform movable from the first position to the second position simultaneously with the robot arm moving from the pick station to the place station.

4. The part manipulator of claim 1, wherein the part gripper includes a first gripper jaw and a second gripper jaw, a holding space defined between the first gripper jaw and the second gripper jaw, wherein the first and second gripper jaws are oriented vertically when the rotation platform is in the first position and the first and second gripper jaws are oriented horizontally when the rotation platform is in the second position.

5. The part manipulator of claim 1, wherein the end effector includes a gripper sensor detecting a position of the part gripper, the robotic arm being controlled based on input from the gripper sensor.

6. The part manipulator of claim 1, wherein the end effector includes a rotation platform sensor detecting a position of the rotation platform, the robotic arm being controlled based on input from the rotation platform sensor.

7. The part manipulator of claim 1, wherein the robotic arm includes a robotic arm actuator and the rotation platform includes a rotation platform actuator, the rotation platform actuator being operated independently of the robotic arm actuator.

8. A part assembly machine comprising:
a pick station having a part feeder, the part feeder having a platform supporting parts;
a vision inspection station positioned adjacent the part feeder, the vision inspection station including an imaging device to image the parts in a field of view above the platform;
a controller receiving images from the imaging device, the controller determining orientations of the parts on the platform from a plurality of possible orientations, the possible orientations including a picking orientation, the controller determining locations of each part of the parts in the picking orientation;
a part manipulator positioned adjacent the pick station to successively pick up the parts that are in the picking orientation from the part feeder, the part manipulator configured to place the corresponding picked up parts at a place station, the part manipulator including a robot arm and an end effector coupled to a distal end of the robot arm, the robot arm operably coupled to the controller, the robot arm movable in three dimensional space between the pick station and the place station, the end effector operably coupled to the controller, the end effector including a rotation platform coupled to the distal end of the robot arm and movable independent of the robot arm, the rotation platform rotatable between a first position and a second position, the end effector including a part gripper coupled to the rotation platform, the part gripper movable between a releasing position and a holding position, the part gripper configured to hold the corresponding picked up parts in the holding position, wherein the part gripper is rotated by the rotation platform as the rotation platform is rotated from the first position to the second position;
wherein the controller operates the robot arm to successively position the end effector proximate to the parts that are in the picking orientations;
wherein the controller operates the end effector to pick up the corresponding part in the picking orientation at the pick station;
wherein the controller operates the end effector to rotate the rotation platform from the first position to the second position to move the part from the picking orientation to a placing orientation;
wherein the controller operates the robot arm to move the end effector to the place station after the part is picked up; and
wherein the controller operates the end effector to release the part in the placing orientation at the place station.

9. The part assembly machine of claim 8, wherein the rotation platform is operable independently of operation of the robot arm, the rotation platform movable from the first position to the second position simultaneously with the robot arm moving from the pick station to the place station.

10. The part assembly machine of claim 8, wherein the part gripper includes a first gripper jaw and a second gripper jaw, a holding space defined between the first gripper jaw and the second gripper jaw, wherein the first and second gripper jaws are oriented vertically when the rotation platform is in the first position and the first and second gripper jaws are oriented horizontally when the rotation platform is in the second position.

11. The part assembly machine of claim 8, wherein the end effector includes a gripper sensor detecting a position of the part gripper, the controller operating the robotic arm based on input from the gripper sensor, the end effector including a rotation platform sensor detecting a position of the rotation platform, the controller operating the robotic arm based on input from the rotation platform sensor.

12. The part assembly machine of claim 8, wherein the robotic arm includes a robotic arm actuator operably coupled to the controller and the rotation platform includes a rotation platform actuator operably coupled to the controller, the rotation platform actuator being operated independently of the robotic arm actuator.

13. The part assembly machine of claim 8, wherein the rotation platform is rotated after initiating movement of the robot arm, rotation of the rotation platform from the first position to the second position is completed prior to completion of movement of the robot arm.

14. The part assembly machine of claim 8, wherein the part manipulator is configured to pick up only the parts in the picking orientation and does not pick up the parts in other orientations.

15. The part assembly machine of claim 8, wherein the platform of the part feeder is vibrated to change orientations of the parts on the upper surface of the platform, and wherein the imaging device images the parts after vibration to identify orientations of the parts after vibration to identify the parts in the picking orientation.

16. A method of assembling parts comprising:
loading the parts on an upper surface of a platform of a part feeder;
imaging the parts on the platform using an imaging device;
processing images to determine orientations of the parts on the platform from a plurality of possible orientations, the possible orientations including a picking orientation, and to determine locations of each of the parts that are in the picking orientation;
successively picking up the parts that are in the picking orientation using a part manipulator including a robot arm movable in three dimensional space and an end effector coupled to a distal end of the robot arm that includes a rotation platform coupled to the distal end of the robot arm and movable independent of the robot arm, the rotation platform rotatable between a first position and a second position and a part gripper coupled to the rotation platform, wherein the part gripper is moved from a releasing position to a holding position to pick up the parts that are in the picking orientation;
after the part is picked up by the end effector, operating the rotation platform to rotate from the first position to the second position to rotate the part from the picking orientation to a placing orientation;
operating the robot arm to move the end effector and the part to a place station in the placing orientation; and
operating the end effector to release the part, in the placing orientation, at the place station.

17. The method of claim 16, wherein said operating the rotation platform occurs simultaneously with said operating the robot arm such that the rotation of the rotation platform occurs while the end effector moves from the picking station to the placing station.

18. The method of claim 16, wherein said operating the rotation platform occurs after initiating said operating the robot arm and said operating the rotation platform is completed prior to completion of said operating the robot arm such that the rotation of the rotation platform from the first position to the second position occurs prior to the robot arm moving the end effector and the part to the place station.

19. The method of claim 16, wherein the part manipulator picks up only the parts in the picking orientation and does not pick up the parts in other orientations.

20. The method of claim 16, further comprising:
vibrating the parts to change orientations of the parts on the upper surface of the platform;
reimaging the parts; and
processing new images of the parts to determine new orientations of the parts.

21. The part manipulator of claim 1, wherein the rotation platform is separate and discrete from the robot arm and coupled to the robot arm.
